(19) United States
(12) Patent Application Publication
(10) Pub. No.: US 2002/0130905 A1
(43) Pub. Date: Sep. 19, 2002

(54) Elevator display control

(75) Inventors: Sarah Blodgett Hughes, Round Rock, TX (US); Allen Chester Wynn, Round Rock, TX (US)

Correspondence Address: Robert V. Wilder, Attorney at Law, 4235 Kingsburg Drive, Round Rock, TX, 78681, US

(73) Assignee: International Business Machines Corporation, Armonk, NY (US)

(21) Appl. No.: 09/810,030

(22) Filed: Mar. 15, 2001

(51) Int. Cl. G06F 3/00

(52) U.S. Cl. 345/810; 345/844

(57) ABSTRACT

A method and implementing system are provided in which existing selection buttons are used in multiple selectable applications. In an exemplary embodiment, a display device and control button are implemented within an elevator environment for use in combination with floor-number selection buttons to control the selection of the display content and screen navigation sequence as well as to select a desired floor-number for elevator movement control. Internet access and navigation are also controlled through the use of the disclosed system.

### FIELD OF THE INVENTION

The present invention relates generally to information processing systems and more particularly to a methodology and implementation for display control input devices.

### BACKGROUND OF THE INVENTION

As the demand for information products, such as the World Wide Web, and information product distribution systems, such as the Internet, continues to increase, the search for new and better methodologies and environments for meeting such demand also continues to grow. Currently, information access devices can be found in many forms including personal computers (PCs), palm-held digital devices and cellular telephones as well as many other wireless devices. Since more and more business and other daily decisions are information-critical, information consumers are demanding information availability and access in every possible daily environment in order to assure that such decisions are based upon the best and most current information available at the time a critical decision has to be made. In addition to the need for being aware of breaking business news, business people and other information consumers need to be aware of other headline news items which may affect their business and other aspects of their daily lives. For example, there is a general need for access to stock market information as well as domestic and foreign headline news and breaking news of general interest. For traveling business people, there are unique requirements for access to other kinds of information such as local weather, airline schedules, late flight departures and other airport-related information.

One environment where display devices may be implemented to provide another information product delivery system is in elevators. With the number of elevator-serviced buildings increasing substantially, there is a growing opportunity to provide a new information delivery system to elevator passengers which can be accessed during otherwise unused transit time. Advertising may also be implemented to provide an additional source of income. However, the installation of new display systems and control devices into elevator systems is considered to be a major effort especially with regard to already existing elevators.

Further, the content of an elevator display system must be able to be selected by the elevator passengers since different passengers will have differing information needs. This requirement also poses a difficult problem since a typical selection device such as a mouse, would not be easily implemented. Thus, the design of a display system and the associated control instrumentation must be such as to avoid over-congestion in the small elevator environment and maintain a relatively aesthetic appearance and yet allow passengers to inter-act with the display device in selecting display options for presented information.

Thus there is a need for an improved and inter-active information display system which is particularly suited for application in an elevator or the like where maximum advantage can be taken of already existing equipment such that only a minimum amount of new system equipment is required.

### SUMMARY OF THE INVENTION

A method and implementing system are provided in which existing selection buttons are used in multiple selectable applications. In an exemplary embodiment, a display device and control button are implemented within an elevator environment for use in combination with floor-number selection buttons to control the selection of the display content and screen navigation sequence as well as to select a desired floor-number for elevator movement control. Internet access and navigation are also controlled through the use of the disclosed system

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of an elevator environment in which the present invention may be implemented;

FIG. 2 is a simplified schematic diagram showing selected components and subsystems of the control and display system illustrated in FIG. 1;

FIG. 3 is an exemplary illustration of a control panel implemented in accordance with the present invention;

FIG. 4 is a flowchart illustrating one exemplary implementation of an operational sequence in accordance with the present invention; and

FIG. 5 is illustration of another implementation of an operational sequence in accordance with the present invention.

### DETAILED DESCRIPTION

The various methods discussed herein may be implemented within a typical computer-related system which may include a workstation or personal computer. In general, an implementing computer system may include a plurality of processors in a multi-bus system in a network of similar systems. However, since the workstation or computer system 101 implementing the present invention in an exemplary embodiment, is generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention.

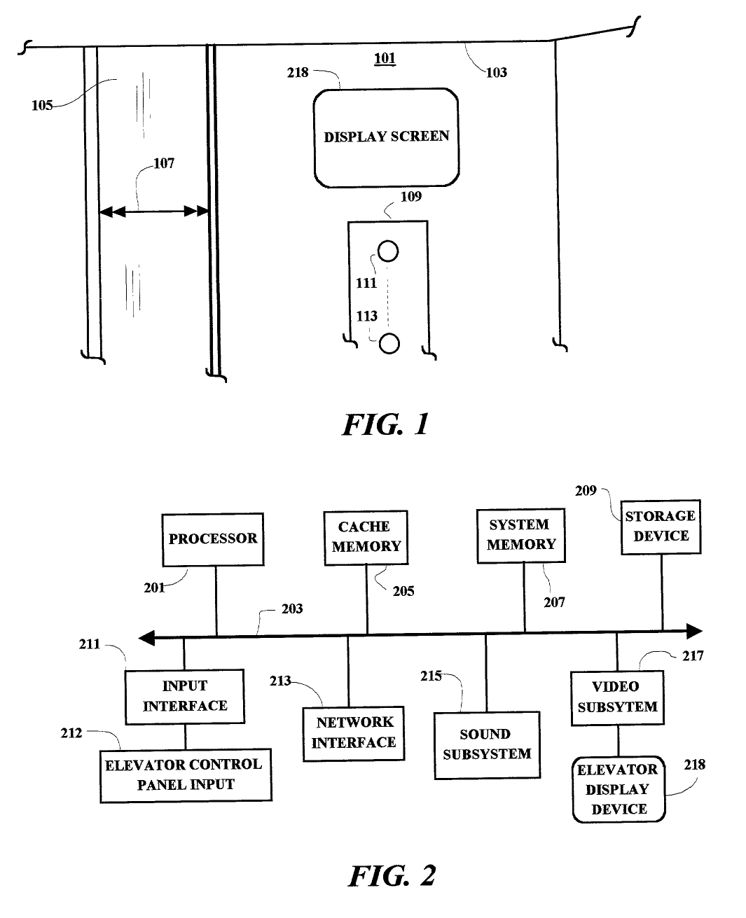

In FIG. 1, there is shown a partial elevational view of an elevator cabin 101. A display screen 218 is mounted above eye-level and close to the ceiling 103 of the elevator in the example. The display may also be mounted in a vertically lower position closer to eye-level if desired. The illustration also shows an elevator door 105 which is arranged to be opened and closed 107 at floor levels which are selected by passengers within the elevator 101. Passengers may select the floors at which the elevator will stop by selecting an appropriate floor button, e.g. 111 and 113, which are arranged on a panel 109 typically mounted on the front wall of the elevator. As is hereinafter described, the display screen 218 can be controlled by passengers through the use of a control button and the floor buttons to navigate through menus presented during, for example, a web browser session being controlled by one or more passengers. In accordance with the present invention, the display screen may, as a default, present a continuous program containing current news headlines. In addition, however, the passengers are provided with the ability to inter-act with the display system to “go to” or navigate to other websites, application programs or any other menu-driven display sequence.

In FIG. 2, there is shown several of the major electronic subsystems which are included in the exemplary embodiment. As shown, a processor 201 is coupled to a system bus 203 which may be any host system bus. It is noted that the processing methodology disclosed herein will apply to many different bus and/or network configurations. A cache memory device 205, and a system memory unit 207 are also connected to the bus 203. The information processing circuitry illustrated in FIG. 2 is arranged to establish a communication link and initiate communication with other processing systems and websites. The system, for example, may be connected through a network connection back to a system or building host or gateway computer for connection to the Internet and selected websites which contain useful information for access

The system bus 203 is shown connected through an input interface circuit 211 to an elevator control panel input device 212. The control panel input circuitry 212 is coupled to the control button and the floor buttons on the control panel 109. The bus 203 is also coupled, inter alia, to a storage device 209 and a separate network subsystem interface 213. The network interface provides a connection to a network server (not shown) for example, which may be accessed by the elevator subsystem. A sound subsystem 215 is also connected to the system bus 203 as well as a video subsystem 217 and the elevator display device 218. Other circuitry and subsystems may also be coupled to the bus 203 to provide enhanced functionality. The video subsystem 217 for example, may include enhanced graphics and the sound subsystem may be a stereo or even surround sound system. As hereinbefore noted, the display device may be of any known technology for presenting display screens to a user. As is well known, application programs including browser programs may be downloaded from selected websites and executed from system memory to produce menu-driven applications on the elevator display screen 218. The system illustrated is selectively operational to present displays on the screen of the display device 218 and respond to user inputs in accordance with the functional flow of the application program being executed. As hereinbefore noted, however, the use of the common mouse device is not readily adapted to an inter-active elevator display.

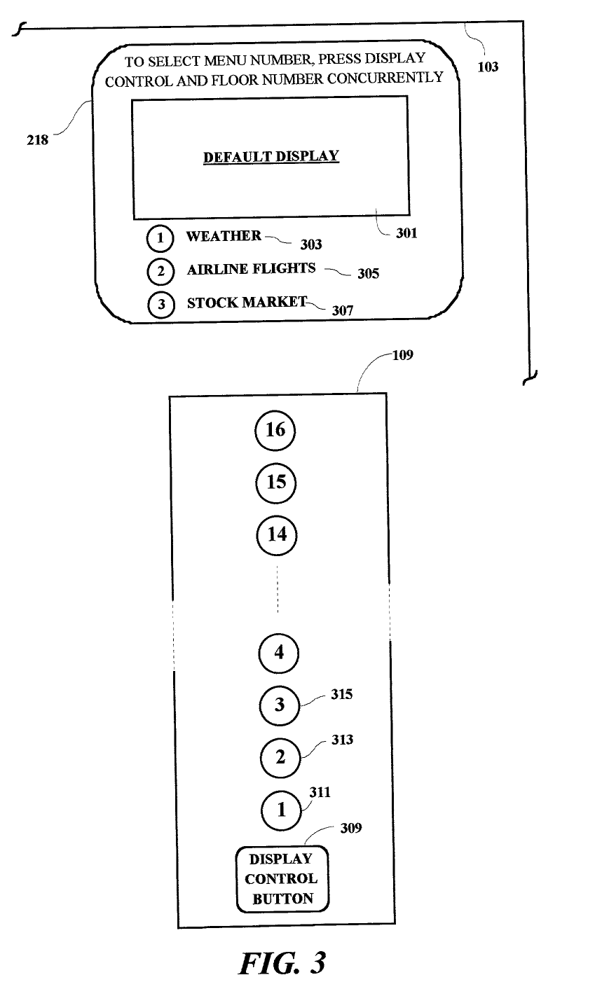

FIG. 3 illustrates a more detailed view of the display device 218 and the control panel 109 shown in FIG. 1. As shown in FIG. 3, the display screen includes a screen area 301 upon which a default program, such as a current news presentation, is displayed. In addition, other passenger selections are shown on the display screen 218. Such selections, for example, may include a “Weather” presentation 303, an “Airline Flight” presentation 305 and a “Stock Market” presentation 307. Many other presentation areas are also possible but only three are shown for the sake of simplicity. FIG. 3 also shows the control panel 109 including floor request buttons such as 311, 313 and 315, as well as a Display Control Button 309. When the Display Control Button 309 is pressed, a display control signal is generated and interpreted, for example, by logic with the elevator control panel input circuitry 212 and input interface 211 to enable certain functions as hereinafter described. Further, the elevator display system may be connected to a local area network or to the Internet for access to the World Wide Web. Local display control circuitry is effective to display numeric designators such as the encircled numerals “1”, “2” and “3” for corresponding menu items 303, 305 and 307. When the system is connected to the Internet, for example, the selection of “1”, “2” or “3” is translated by code or by logic within the input interface 211, into a corresponding website address or uniform resource locator (URL) for weather, airline or stock market information, respectively. The designated website is then accessed by the elevator display system network interface 213. Thus the actuation of a selected floor request button in combination with the control switch 309 is effective to enable passenger input to access, for example, a selected website which is, in turn, able to cause the display of the selected type of information desired by a passenger.

As indicated by the directions at the top of the display, in order to choose one of the available programming selections 303, 305 or 307, a passenger is directed to concurrently press the Display Control Button 309 and the floor number button corresponding to the passenger's menu selection. The encircled floor designations adjacent to the selections 303, 305 and 307 are non-functional displayed indicia for reference only and are not actual floor buttons. The actual floor buttons are shown within the panel 109. As an alternative, the control circuitry may be arranged to generate and hold a control signal at a predetermined voltage level for a minimal predetermined time period so that a subsequent actuation of a floor button during the control “ON” time period, will effect the selection of the corresponding menu item. In either example, the system is designed not to interfere with the normal operation of the elevator in response to the normal use of the floor buttons. The Display Control Button may also be arranged for a toggle on-off action in combination although the toggle operation would not be preferred at the present time since it would be less user-friendly relative to normal elevator operations.

Thus, through the use of the Display Control Button 309 in combination with the normal elevator floor selection buttons, the floor buttons are able to provide a dual function by enabling selection of display screen menu-driven options as well as to provide the normal function of inputting a floor level at which a passenger wishes to stop the elevator.

When a menu selection is made by a passenger, the selected information will be presented on the display screen and a “Default” option will appear on the screen to enable the passenger to return to the default presentation. Optionally, the selected program will be presented for only a predetermined period of time and then return automatically to the default presentation.

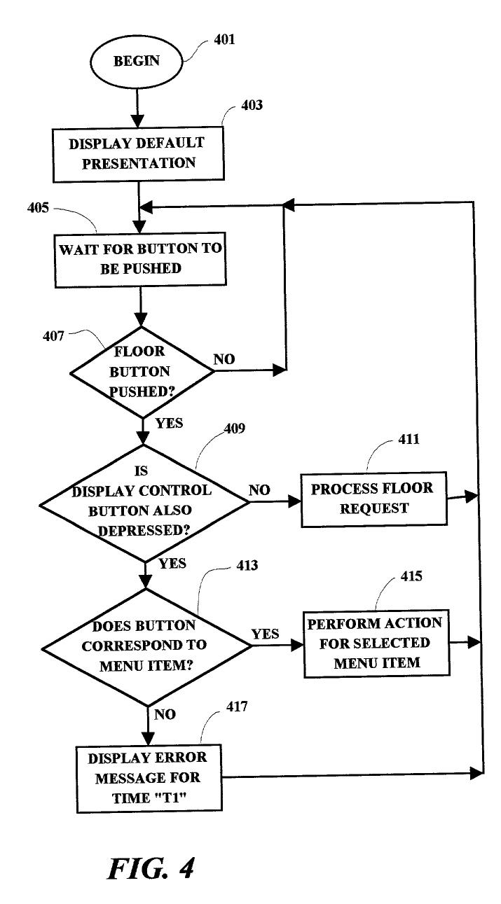

One exemplary operation sequence is illustrated in the flowchart of FIG. 4. Specific logic circuitry or code implementation to perform the logic functions herein described in the illustrated flowcharts is considered to be known to those skilled in the art and more specific details are not further set forth herein in order to avoid unnecessary detail and distraction from the broad scope of the present invention. As shown, the processing begins 401 and displays the default presentation 403. As hereinbefore noted, this may be a continuously updated listing of headline news with or without accompanying related verbal descriptions and other audio effects. The system will continue to await the actuation of a button 405. When a button is pressed, it is determined if the button is a floor button 407. In the example shown in FIG. 4, if the Control button is pressed without a concurrent pressing of a floor button, there will be no response by the system. If it is determined that a floor button is pressed at the same time as the control button 409, then a check is made to determine if the floor button corresponds to one of the menu selection items displayed 413, and if so, then the selected menu item is performed 415 and the process returns to wait for another button to be pushed 405. If a floor button is pushed without a concurrent control button actuation 409, then it is interpreted and processed as a normal elevator floor request 411 and the process returns to await another button actuation 405. If both the control button and a floor button are pushed at the same time but the floor button does not correspond to a menu item 413, then an error message is displayed for a predetermined time “T1” and the process returns to await the next button actuation 405.

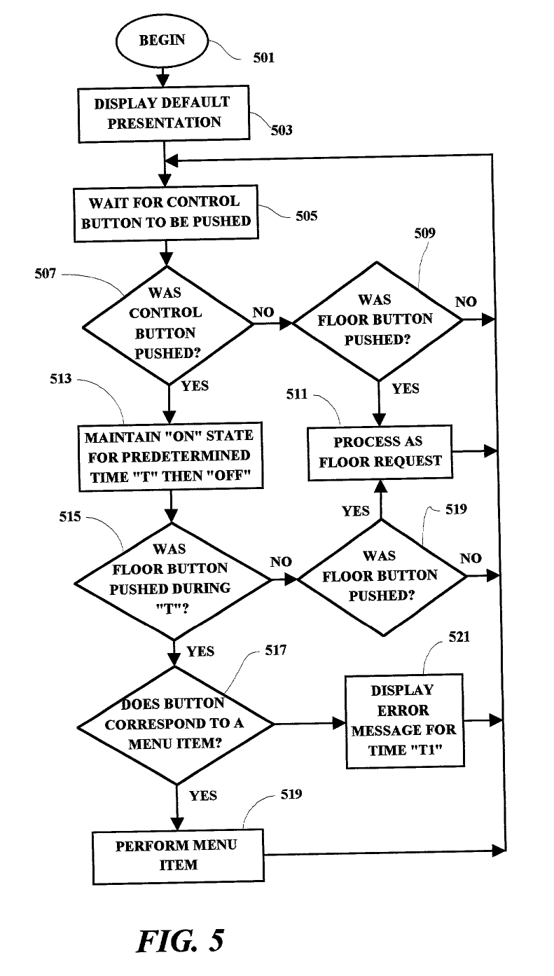

An alternate flow sequence is presented in FIG. 5. As shown, the flow presented in FIG. 5 may be implemented to provide a “holding” function so that the control and floor buttons do not need to be pressed simultaneously in order to make a menu selection. In other words, as shown in FIG. 5, when the control button 309 is pressed, it is held for a predetermined time period “T” and if a floor button is pressed at any time during that time period, the corresponding menu item will be selected. As shown in FIG. 5, the process begins 501 and displays a default presentation 503. The process will await the next button to be pushed 505 and when it is detected that the control button was pushed 507, an “ON” signal is generated and maintained for a predetermined time “T” and then returned to an “OFF” state. During time “T” a check is made to detect a pressing of a floor button during time “T” 515, and if a floor button is pressed during time “T”, a check is made to determine if the floor button number corresponds to a menu selection number 517. If there is a menu item corresponding to the floor button number, then the selected menu item is performed 519 and the process returns to await the next button actuation 505. If it is detected that a floor button is pushed outside of the time period “T” 509, 519, then the actuation of the floor button is processed as a normal floor request 511 and the process returns to await another button actuation 505. If it is detected that a floor button was pushed during time “T” but the floor number does not correspond to a possible menu selection 517, then an error message is displayed for a short period of time “T1” and the process returns to await the next button actuation 505.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely in program code and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for enabling passenger input to a display system, said display system including a display device arranged within an elevator for viewing by elevator passengers, said elevator including a plurality of designated floor request buttons arranged for selective actuation by said passengers for designating floors at which said elevator will stop, said method comprising:
providing a display control switching device; and
enabling usage of said display control switching device in combination with said designated floor request buttons for providing said passenger input to said display system.

2. The method as set forth in claim 1 and further including coupling said display system to a network.

3. The method as set forth in claim 2 wherein said network is a local area network.

4. The method as set forth in claim 1 and further including coupling said display system to an Internet for accessing remote websites by actuating said display control switching device in combination with said designated floor request buttons.

5. The method as set forth in claim 1 wherein said display system is operable to display a listing of menu items for selection by said elevator passengers, said menu items being selectable by concurrent actuation of said display control switching device and one of said designated floor request buttons, said one of said designated floor request buttons corresponding to a selected one of said menu items.

6. The method as set forth in claim 1 wherein said display system is operable to display a listing of menu items for selection by said elevator passengers, said menu items being selectable by actuation of a floor request button corresponding to a selected menu item, said actuation occurring within a predetermined time following an actuation of said display control switching device.

7. The method as set forth in claim 1 wherein said display system is operable to display a listing of menu items for selection by said elevator passengers, wherein said menu items include at least one menu item corresponding to a remote website, said display system being selectively coupled to said remote website by using said display control switching device in combination with one floor request button corresponding to said remote website.

8. The method as set forth in claim 5 and further including:
determining that a selected floor request button actuation corresponds to a displayed menu item; and
displaying an error message on said display device if said selected floor request button actuation does not correspond to a selectable one of said menu items.

9. The method as set forth in claim 8 wherein said error message is displayed only for a predetermined period of time.

10. The method as set forth in claim 6 and further including:
determining that a selected floor request button actuation corresponds to a displayed menu item; and
displaying an error message on said display device if said selected floor request button actuation does not correspond to a selectable one of said menu items.

11. The method as set forth in claim 10 wherein said error message is displayed only for a predetermined period of time.

12. The method as set forth in claim 7 and further including:
determining that a selected floor request button actuation corresponds to a displayed menu item; and
displaying an error message on said display device if said selected floor request button actuation does not correspond to a selectable one of said menu items.

13. The method as set forth in claim 12 wherein said error message is displayed only for a predetermined period of time.

14. A processing system including a system bus, and a processor, a display system, a memory system, a network interface system, an input interface system, all coupled to said system bus, said display system including a display device arranged within an elevator for viewing by elevator passengers, said elevator including a plurality of designated floor request buttons coupled to said input interface system and arranged for selective actuation by said passengers for designating floors at which said elevator will stop, said processing system further including a display control switching device, said display control switching device being selectively operable in combination with said designated floor request buttons for enabling passenger input to said display system.

15. The system as set forth in claim 14 and further including means for coupling said display system to a network.

16. The system as set forth in claim 15 wherein said network is a local area network.

17. The system as set forth in claim 14 and further including means for coupling said display system to an Internet for accessing remote websites by actuating said display control switching device in combination with said designated floor request buttons.

18. The system as set forth in claim 14 wherein said display system is operable to display a listing of menu items for selection by said elevator passengers, said menu items being selectable by concurrent actuation of said display control switching device and one of said designated floor request buttons, said one of said designated floor request buttons corresponding to a selected one of said menu items.

19. The system as set forth in claim 14 wherein said display system is operable to display a listing of menu items for selection by said elevator passengers, said menu items being selectable by actuation of a floor request button corresponding to a selected menu item, said actuation occurring within a predetermined time following an actuation of said display control switching device.

20. The system as set forth in claim 14 wherein said display system is operable to display a listing of menu items for selection by said elevator passengers, wherein said menu items include at least one menu item corresponding to a remote website, said display system being selectively coupled to said remote website by using said display control switching device in combination with one floor request button corresponding to said remote website.

21. The system as set forth in claim 18 and further including means for determining that a selected floor request button actuation corresponds to a displayed menu item, and means for displaying an error message on said display device if said selected floor request button actuation does not correspond to a selectable one of said menu items.

22. The system as set forth in claim 21 wherein said error message is displayed only for a predetermined period of time.

23. The system as set forth in claim 19 and further including means for determining that a selected floor request button actuation corresponds to a displayed menu item, and means for displaying an error message on said display device if said selected floor request button actuation does not correspond to a selectable one of said menu items.

24. The system as set forth in claim 23 wherein said error message is displayed only for a predetermined period of time.

25. The system as set forth in claim 20 and further including means for determining that a selected floor request button actuation corresponds to a displayed menu item, and means for displaying an error message on said display device if said selected floor request button actuation does not correspond to a selectable one of said menu items.

26. The system as set forth in claim 25 wherein said error message is displayed only for a predetermined period of time.
